(19) United States
(12) Patent Application Publication
(10) Pub. No.: US 2026/0100929 A1
(43) Pub. Date: Apr. 9, 2026

(54) MANAGEMENT OF DEGRADED CELLULAR NETWORK FUNCTIONS DEPLOYED OVER A CLOUD

(71) Applicant: DISH Wireless L.L.C., Englewood, CO (US)

(72) Inventors: Mohammad Dawood Shahdad, Aurora, CO (US); Prakashkumar M. Patel, Castle Rock, CO (US); Kevin Plunkett, Aurora, CO (US); Brian Louis Peletz, Aurora, CO (US); Brijesh Kumar Mishra, Highland Ranch, CO (US)

(21) Appl. No.: 18/910,984

(22) Filed: Oct. 9, 2024

(51) Int. Cl. H04L 61/5046; H04L 61/4511; H04L 61/5076; H04L 65/1104

(52) U.S. Cl. CPC H04L 61/5046; H04L 61/4511; H04L 61/5076; H04L 65/1104

(57) ABSTRACT

A method is for operating a computing system for functional integration with a domain name system (DNS) resolver. The method includes repeatedly performing an attempt to connect, using the DNS resolver, to a network function module located within a core of a cellular network. The method includes detecting a first threshold number of unsuccessful connection attempts to the network function module and causing, in response to the detecting, the DNS resolver to remove one or more records, for the network function module, from a hosted zone that includes the network function module.

### BACKGROUND

One type of cellular network is a Fifth generation (5G) wireless network, although this disclosure may apply to other modern cellular networks, including a 6G wireless network. In a 5G wireless network, a 5G Core Network (5G core) is responsible for managing and routing data traffic, providing various network resources and services, and supporting the core functionalities of the cellular network. Fifth generation wireless networks have the promise to provide higher throughput, lower latency, and higher availability compared with previous global wireless standards. A combination of control and user plane separation (CUPS) and multi-access edge computing (MEC), which allows compute and storage resources to be moved from a centralized cloud location to the “edge” of a network and closer to end user devices and equipment, may enable low-latency applications with millisecond response times.

User plane function (UPF) nodes may be located within the core network and be configured to transport IP data traffic (e.g., user plane traffic) between user equipment (UE) and a data network and for handling packet data unit (PDU) sessions with the data network. User plane function or UPF nodes may support the separation of control plane (CP) and user plane (UP) functions in the 5G architecture. This separation allows for independent scaling, flexibility, and deployment of the control and user plane functions.

A domain name server (DNS) resolver can be employed that facilitates the communication of aspects of the (e.g., 5G, 6G) core network with a cloud, e.g., where the DNS resolver is associated or integrated with the cloud. A public (or private) cloud can be understood as a networked group of servers that provide Internet-based storage, computing, and networking along with associated security for data being processed and stored at one or more IP addresses. Thus, a specific DNS resolver can be configured to facilitate interaction between particular 5G core network function (NF) components and the cloud, where the NF components can be located in, e.g., an Internet protocol (IP) multimedia subsystem (IMS) node and/or an evolved packet core (EPC) node of the 5G core network.

### BRIEF DESCRIPTION OF THE DRAWINGS

The present disclosure is illustrated by way of example, and not by way of limitation, in the figures of the accompanying drawings.

FIG. 1A is a block diagram depicting a 5G network including a radio access network (RAN) and a core network according to at least one embodiment.

FIG. 1B is a block diagram depicting a portion of the 5G network of FIG. 1A along with private or public cloud supporting infrastructure according to some embodiments.

FIG. 2 is a flow diagram of a method for managing a degraded network function (NF) component deployed over a private or public cloud according to some embodiments.

FIG. 3A is a flow diagram of a method for removing one or more records of the degraded NF component from a DNS resolver according to some embodiments.

FIG. 3B is a flow diagram of a method for adding one or more records of a revived NF component to a DNS resolver according to some embodiments.

FIG. 4 illustrates a block diagram illustrating an exemplary computer device, in accordance with implementations of the present disclosure.

### DETAILED DESCRIPTION

Technologies for managing degraded cellular network function (NF) components over a cloud where the NF components reside within a cellular network (e.g., 5G wireless network, 6G wireless network) are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, a specific DNS resolver can be configured to facilitate interactions between particular core network function (NF) components and the cloud, where the NF components can be located in, e.g., an Internet protocol multimedia subsystem (IMS) node and/or an evolved packet core (EPC) node of the 5G core network, which will be discussed in more detail. In certain deployments of such a DNS resolver, when target NF components become degraded (which also includes being defective or powered off), certain source NF components continue try to connect (or listen) to the degraded target NF components. This causes significant loss of performance and throughput between the core network and the cloud. Until now, the solution has been to receive reports or alerts about certain degraded NF components and manually remove record entries from the DNS resolver so as to steer traffic away from the degraded NF components. This solution is slow and subject to human error, negatively impacting quality of service.

Aspects and embodiments of the present disclosure address the above and other deficiencies by employing a computing system (e.g., an intelligent computer) that is associated or integrated with the DNS resolver and able to intelligently detect degraded NF components and remove record entries, e.g., from a hosted zone of the DNS resolver. In this way, with a sufficient number of the routing-type record entries removed, the traffic that would try to connect to the degraded NF components will be steered elsewhere or shut down.

For example, in some embodiments, the computing system includes one or more processing devices and memory communicatively coupled with and readable by the one or more processing devices. The memory can have stored therein processor-readable instructions which, when executed by the one or more processing devices, cause the one or more processing devices to perform operations. These operations can include, for example, repeatedly performing an attempt to connect, using the DNS resolver, to a network function module located within a core of a cellular network, e.g., a 5G or 6G network core. The operations can further include detecting a threshold number of unsuccessful connection attempts to the network function module, e.g., 6, 12, 15, 18, or the like. The operations can further include causing, in response to detecting a threshold number of unsuccessful connection attempts to the network function module, the DNS resolver to remove one or more records, for the network function module, from a hosted zone that includes the network function module.

In additional embodiments, once the one or more records have been removed from entries in the DNS resolver, the operations can further include repeatedly performing the attempt to connect to the network function module, using the DNS resolver, located within the core of the cellular network. In this way, the computing system can monitor whether the degraded NF components reactivates or comes back online sufficiently to be responsive. In response to detecting a threshold number of successful connection attempts to the network function module (e.g., 8, 12, 24, 30, or the like), the operations can include causing the DNS resolver to add one or more records, for the network function module, to a hosted zone that includes the network function module. In this way, once the reason for degradation is resolved, DNS-related records can be restored to the DNS resolver for the NF component.

Therefore, advantages of the systems and methods implemented in accordance with some embodiments of the present disclosure include removing error-prone human interventions when steering traffic away from degraded NF components by way of updates to record entries in the relevant DNS resolver. The disclosed solutions can thus seamlessly address reduction in performance and throughput (due to degraded NF components), increasing the quality of service provided to users that would otherwise deploy source NF components to continue steering traffic toward such degraded NF components. These and other advantages that would be apparent to those skilled in the art will be apparent from the following more detailed discussion.

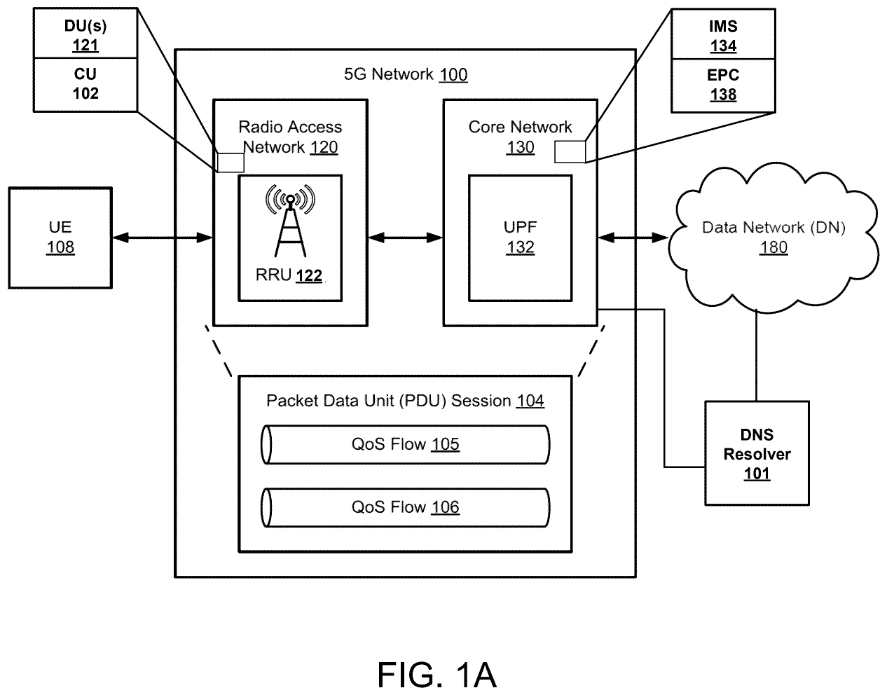

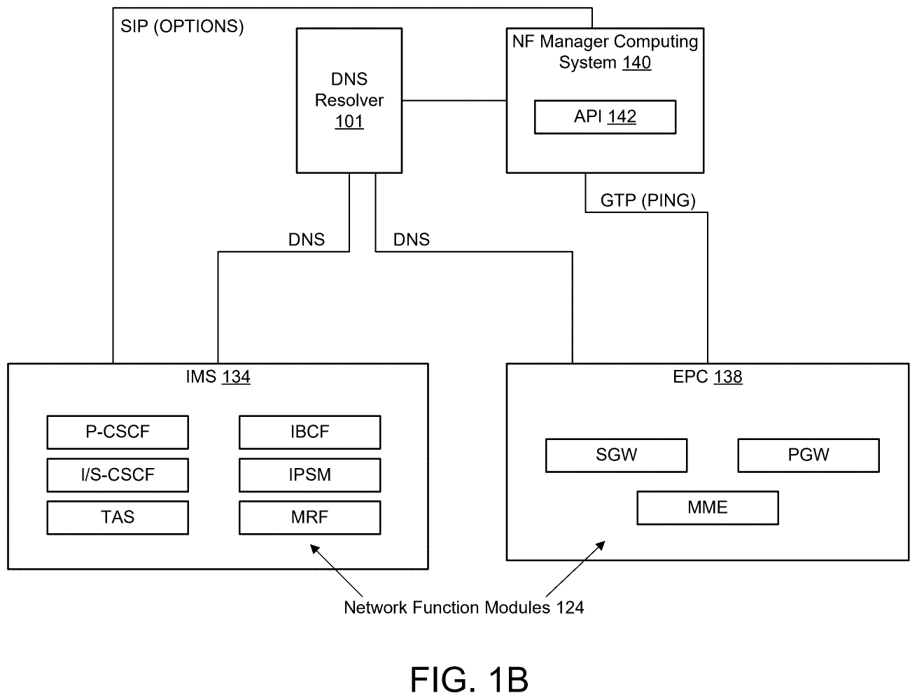

FIG. 1A depicts a 5G network 100 including a radio access network (RAN) 120 and a core network 130 according to at least one embodiment. The RAN 120 can include a new-generation radio access network (NG-RAN) that uses the 5G new radio interface (NR). The 5G network 100 connects user equipment (UE) 108 to the data network (DN) 180 using the RAN 120 and the core network 130. The data network 180 can include the Internet, a local area network (LAN), a wide area network (WAN), a private data network, a wireless network, a wired network, or a combination of such networks.

In embodiments, the UE 108 includes an electronic device with wireless connectivity or cellular communication capability, such as a mobile phone 110 or handheld computing device 112. In at least one example, the UE 108 can include a 5G smartphone or a 5G cellular device that connects to the RAN 120 via a wireless connection. The UE 108 can include one of a number of UEs not depicted that are in communication with the RAN 120. The UEs may include mobile and non-mobile computing devices. The UEs may include laptop computers, desktop computers, an Internet-of-Things (IoT) devices, and/or any other electronic computing device that includes a wireless communications interface to access the RAN 120.

In at least some embodiments, the RAN 120 includes one or more distributed units (DU(s)) 121, a central unit (CU) 102, and a remote radio unit (RRU) 122 for wirelessly communicating with UE 108. In some embodiments, the DU(s) 121 and the CU 102 of the RAN 120 may be co-located with the RRU 122. In other embodiments, the DU(s) 121 and the RRU 122 may be co-located at a cell site and the CU 102 may be located within a local data center (LDC) that is in close proximity to the cell site.

In embodiments, the split DU/CU architecture may provide flexibility, scalability, and efficiency in network deployment and operation. For example, each DU 121 may handle the real-time, lower-layer aspects of baseband processing, including the lower layer of the protocol stack, acting as intermediary between the CU 102 and the RRU 122. The DU 121 functionality may include physical layer (PHY) functions such as error correction, modulation/demodulation, and forward error correction (FEC). These DUs 121 may be responsible for dynamic radio resource management tasks, including scheduling of user data, allocation of radio resources, power control, and interference management, all towards optimizing the performance and efficiency of the radio access network.

The RRU 122 can include a Radio Unit (RU) and may include one or more radio transceivers for wirelessly communicating with UE 108. The remote radio unit (RRU) 122 may include circuitry for converting signals sent to and from an antenna of a Base Station into digital signals for transmission over packet networks. The RAN 120 may correspond with a 5G radio Base Station that connects user equipment to the core network 130. The 5G radio Base Station may be referred to as a generation Node B, a “gNodeB,” or a “gNB. ” A Base Station may refer to a network element that is responsible for the transmission and reception of radio signals in one or more cells to or from user equipment, such as UE 108.

The core network 130 may utilize a cloud-native service-based architecture (SBA) in which different core network functions (e.g., authentication, security, session management, and core access and mobility functions) are virtualized and implemented as loosely coupled independent services that communicate with each other, for example, using HTTP protocols and application programming interfaces (APIs). In some cases, control plane (CP) functions may interact with each other using the service-based architecture. In at least one embodiment, a microservices-based architecture in which software is composed of small independent services that communicate over well-defined APIs may be used for implementing some of the core network functions. For example, CP network functions for performing session management may be implemented as containerized applications or microservices. Although a microservice-based architecture does not necessarily require a container-based implementation, a container-based implementation may offer improved scalability and availability over other approaches. Network functions that have been implemented using microservices may store their state information using the unstructured data storage function (UDSF) that supports data storage for stateless network functions across the service-based architecture (SBA).

The primary core network functions can include the access and mobility management function (AMF), the session management function (SMF), and a user plane function (UPF) node, all of which may provide user session capability and user data. The UPF (e.g., UPF node 132) may perform packet processing including routing and forwarding, quality of service (QoS) handling, and packet data unit (PDU) session management. The UPF node 132 may serve as an ingress and egress point for user plane traffic and provide anchored mobility support for user equipment. For example, the UPF node 132 may provide an anchor point between the UE 108 and the data network 180 as the UE 108 moves between coverage areas. The AMF may act as a single-entry point for an UE connection and perform mobility management, registration management, and connection management between a data network and UE. The SMF may perform session management, user plane selection, and IP address allocation.

Other core network functions may include a network repository function (NRF) for maintaining a list of available network functions and providing network function service registration and discovery, a policy control function (PCF) for enforcing policy rules for control plane functions, an authentication server function (AUSF) for authenticating user equipment and handling authentication related functionality, a network slice selection function (NSSF) for selecting network slice instances, and an application function (AF) for providing application services. Application-level session information may be exchanged between the AF and PCF (e.g., bandwidth requirements for QoS). In some cases, when user equipment requests access to resources, such as establishing a PDU session or a QoS flow, the PCF may dynamically decide if the user equipment should grant the requested access based on a location of the user equipment.

A network slice can include an independent end-to-end logical communications network that includes a set of logically separated virtual network functions. Network slicing may allow different logical networks or network slices to be implemented using the same compute and storage infrastructure. Therefore, network slicing may allow heterogeneous services to coexist within the same network architecture via allocation of network computing, storage, and communication resources among active services. In some cases, the network slices may be dynamically created and adjusted over time based on network requirements. For example, some networks may require ultra-low-latency or ultra-reliable services. To meet ultra-low-latency requirements, components of the RAN 120, such as the DUs 121 and the CU 102, may need to be deployed at a cell site or in an LDC that is in close proximity to a cell site such that the latency requirements are satisfied (e.g., such that the one-way latency from the cell site to the DU 121 component or CU 102 component is less than ˜1.2 milliseconds (ms)).

The 5G network 100 may provide one or more network slices, where each network slice may include a set of network functions that are selected to provide specific telecommunications services. For example, each network slice can include a configuration of network functions, network applications, and underlying cloud-based compute and storage infrastructure. In some cases, a network slice may correspond with a logical instantiation of a 5G network, such as an instantiation of the 5G network 100. In some cases, the 5G network 100 may support customized policy configuration and enforcement between network slices per service level agreements (SLAs) within the RAN 120. User equipment, such as UE 108, may connect to multiple network slices at the same time (e.g., eight different network slices). In one embodiment, a PDU session, such as PDU session 104, may belong to only one network slice instance. In some cases, the 5G network 100 may dynamically generate network slices to provide telecommunications services for various use cases, such the enhanced Mobile Broadband (eMBB), Ultra-Reliable and Low-Latency Communication (URLCC), and massive Machine Type Communication (mMTC) use cases.

A cloud-based compute and storage infrastructure can include a networked computing environment that provides a cloud computing environment for interaction with and implementation of aspects the 5G network 100. Cloud computing may refer to Internet-based computing, where shared resources, software, and/or information may be provided to one or more computing devices on-demand via the Internet (or other network). The term “cloud” may be used as a metaphor for the Internet, based on the cloud drawings used in computer networking diagrams to depict the Internet as an abstraction of the underlying infrastructure it represents. In some embodiments, the “cloud” as referred to herein can further include the data network 180 and a DNS resolver 101.

The core network 130 may include a set of network elements that are configured to offer various data and telecommunications services to subscribers or end users of user equipment, such as UE 108. Examples of network elements include network computers, network processors, networking hardware, networking equipment, routers, switches, hubs, bridges, radio network controllers, gateways, servers, virtualized network functions, and network functions virtualization infrastructure. A network element can include a real or virtualized component that provides wired or wireless communication network services.

Virtualization allows virtual hardware to be created and decoupled from the underlying physical hardware. One example of a virtualized component is a virtual router (or a vRouter). Another example of a virtualized component is a virtual machine (VM). A virtual machine can include a software implementation of a physical machine. The virtual machine may include one or more virtual hardware devices, such as a virtual processor, a virtual memory, a virtual disk, or a virtual network interface card. The virtual machine may load and execute an operating system and applications from the virtual memory. The operating system and applications used by the virtual machine may be stored using the virtual disk. The virtual machine may be stored as a set of files including a virtual disk file for storing the contents of a virtual disk and a virtual machine configuration file for storing configuration settings for the virtual machine. The configuration settings may include the number of virtual processors (e.g., four virtual CPUs), the size of a virtual memory, and the size of a virtual disk (e.g., a 64GB virtual disk) for the virtual machine. Another example of a virtualized component is a software container or an application container that encapsulates an application's environment.

In some embodiments, applications and services may be run using virtual machines instead of containers in order to improve security. A common virtual machine may also be used to run applications and/or containers for a number of closely related network services.

The 5G network 100 may implement various network functions, such as the core network functions and radio access network functions, using a cloud-based compute and storage infrastructure. A network function module may be implemented as a cloud-native network function (CNF) in the cloud. In some embodiments, for example, the core network 130 includes an internet protocol (IP) multimedia subsystem or IMS 134 and/or an evolved packet core or EPC 138, each of which includes multiple network function modules that will be discussed in detail.

In various embodiments, a network function module may be implemented as a software instance running on hardware or as a virtualized network function. Virtual network functions (VNFs) can include implementations of network functions as software processes or applications. In at least one example, a virtual network function (VNF) may be implemented as a software process or application that is run using virtual machines (VMs) or application containers within the cloud-based compute and storage infrastructure. Application containers (or containers) allow applications to be bundled with their own libraries and configuration files, and then executed in isolation on a single operating system (OS) kernel. Application containerization may refer to an OS-level virtualization method that allows isolated applications to be run on a single host and access the same OS kernel. Containers may run on bare-metal systems, cloud instances, and virtual machines. Network functions virtualization may be used to virtualize network functions, for example, via virtual machines, containers, and/or virtual hardware that runs processor readable code or executable instructions stored in one or more computer-readable storage mediums (e.g., one or more data storage devices).

While the IMS 134 will be discussed in more detail with reference to later Figures, in the context of 5G networks, IMS nodes refer to the various components that make up the IMS architecture, which is designed to deliver IP multimedia services. Thus, IMS can be considered a standardized Next Generation Networking (NGN) architecture used by telecom operators to provide multimedia services across both wireless and wired connections. The introduction of IMS in 5G networks can allow for the convergence of voice, video, messaging, and data services onto a common platform, leveraging IP (Internet Protocol) technology.

Further, while the EPC 138 will be discussed in more detail with reference to later Figures, the EPC 138 can be understood to be the core network architecture used primarily in 4G LTE networks but also that plays a transitional role in the early stages of 5G deployment, particularly in Non-Standalone (NSA) 5G networks. The EPC 138 can be used for managing data connectivity and mobility for devices connected to LTE and early 5G networks.

As discussed previously, the DNS resolver 101 can be configured to facilitate interactions between particular core network function components and the cloud, which could be a private or a public cloud. As just one example (although other DNS resolvers 101 are envisioned), the Amazon® Route 53 resolver is a feature of Amazon® Web Services (AWS®) Route 53 that provides DNS service for VPCs (Virtual Private Clouds) to resolve domain names into IP addresses and vice versa. In the context of AWS®, Route 53 can perform DNS resolution between VPCs and on-premises networks, or between VPCs themselves. This makes it an integral part of network architectures in AWS®, especially for more complex setups such as those required for 5G core and IP Multimedia Subsystem (IMS) deployments.

In a 5G network, DNS plays a role in the discovery of network functions and services. For a 5G core or IMS deployment on AWS®, Route 53 can be configured to handle DNS queries for service discovery. The Route 53 resolver can resolve the service names of network functions (like AMF, SMF, UPF, and those of IMS and EPC in a 5G Core) to their respective IP addresses managed within the AWS® environment.

In some embodiments, the Route 53 resolver can manage both public and private DNS zones. For internal network functions and communications within the AWS® cloud (e.g., between different VPCs), private zones can be used. For services that need to be exposed externally, public DNS zones can be configured. If there are components of the network that reside outside AWS® (such as elements of the IMS or connections to other operator networks), the Route 53 resolver can be set up with conditional forwarding rules. This means that queries for specific domains can be forwarded to external DNS servers, while AWS® handles all other queries internally.

Resolver endpoints (both inbound and outbound) can be configured to facilitate DNS query resolution between the AWS® environment and external networks. Inbound endpoints allow external queries to be resolved using AWS® DNS infrastructure, beneficial for integrating with external 5G components. Outbound endpoints allow DNS queries from AWS® to external DNS resolvers, essential for resolving external names used by the 5G core or IMS. Route 53 Resolver also includes features that enhance security, such as query logging, which allows monitoring and logging of all DNS queries. This can be important for compliance and security monitoring in a 5G deployment. Deploying DNS using Route 53 in a 5G core on AWS® ensures high availability and scalability. Route 53 is designed to automatically scale to handle large volumes of DNS queries, which is helpful in the 5G context where the number of devices and the amount of data traffic can be enormous.

The Route 53 resolver can set up DNS zones by defining and configuring public and private DNS zones according to the network architecture. The Route 53 resolver can also establish and configure resolver rules for DNS resolution paths, including conditional forwarding if necessary. The Route 53 resolver can also set up inbound and outbound resolver endpoints to manage the flow of DNS queries in and out of the AWS® network. The Route 53 resolver can also enable logging and monitoring by turning on DNS query logging for security and troubleshooting. By leveraging the Amazon® Route 53 resolver, a 5G core or IMS deployment on AWS® can achieve robust, secure, and efficient DNS resolution, which provides for network reliability and performance.

As depicted in FIG. 1A, the core network 130 includes a user plane function (UPF) node 132 for transporting IP data traffic (e.g., user plane traffic) between the UE 108 and the data network 180 and for handling PDU sessions with the data network 180. The UPF node 132 can include an anchor point between the UE 108 and the data network 180. The UPF node 132 may be implemented as a software process or application running within a virtualized infrastructure or a cloud-based compute and storage infrastructure. The 5G network 100 may connect the UE 108 to the data network 180 using a PDU session 104, which can include part of an overlay network.

The PDU session 104 may utilize one or more quality of service (QoS) flows, such as QoS flows 105 and 106, to exchange traffic (e.g., data and voice traffic) between the UE 108 and the data network 180. The one or more QoS flows can include the finest granularity of QoS differentiation within the PDU session 104. The PDU session 104 may belong to a network slice instance through the 5G network 100. To establish user plane connectivity from the UE 108 to the data network 180, an AMF that supports the network slice instance may be selected and a PDU session via the network slice instance may be established. In some cases, the PDU session 104 may be of type IPv4 or IPv6 for transporting IP packets. The RAN 120 may be configured to establish and release parts of the PDU session 104 that cross the radio interface.

The RAN 120 may include a set of one or more remote radio units (RRUs) that includes radio transceivers (or combinations of radio transmitters and receivers) for wirelessly communicating with UEs. The set of RRUs may correspond with a network of cells (or coverage areas) that provide continuous or nearly continuous overlapping service to UEs, such as UE 108, over a geographic area. Some cells may correspond with stationary coverage areas and other cells may correspond with coverage areas that change over time (e.g., due to movement of a mobile RRU).

In some cases, the UE 108 may be capable of transmitting signals to and receiving signals from one or more RRUs 122 within the network of cells over time. One or more cells may correspond with a cell site. The cells within the network of cells may be configured to facilitate communication between UE 108 and other UEs and/or between UE 108 and a data network, such as data network 180. The cells may include macrocells (e.g., capable of reaching 18 miles) and small cells, such as microcells (e.g., capable of reaching 1.2 miles), picocells (e.g., capable of reaching 0.12 miles), and femtocells (e.g., capable of reaching 32 feet). Small cells may communicate through macrocells. Although the range of small cells may be limited, small cells may enable mmWave frequencies with high-speed connectivity to UEs within a short distance of the small cells. Macrocells may transit and receive radio signals using multiple-input multiple-output (MIMO) antennas that may be connected to a cell tower, an antenna mast, or a raised structure.

Referring to FIG. 1A, the UPF node 132 may be responsible for routing and forwarding user plane packets between the RAN 120 and the data network 180. Uplink packets arriving from the RAN 120 may use a general packet radio service (GPRS) tunneling protocol (or GTP) to reach the UPF node 132. The GPRS tunneling protocol for the user plane (GTP-U) may support multiplexing of traffic from different PDU sessions by tunneling user data over the interface between the RAN 120 and the UPF node 132.

The UPF node 132 may remove the packet headers belonging to the GTP tunnel before forwarding the user plane packets towards the data network 180. As the UPF node 132 may provide connectivity towards other data networks in addition to the data network 180, the UPF node 132 ensures that the user plane packets are forwarded towards the correct data network. Each GTP tunnel may belong to a specific PDU session, such as PDU session 104. Each PDU session may be set up towards a specific data network name (DNN) that uniquely identifies the data network to which the user plane packets should be forwarded. The UPF node 132 may keep a record of the mapping between the GTP tunnel, the PDU session, and the DNN for the data network to which the user plane packets are directed.

Downlink packets arriving from the data network 180 are mapped onto a specific QoS flow belonging to a specific PDU session before forwarded towards the appropriate RAN 120. A QoS flow may correspond with a stream of data packets that have equal quality of service (QoS). A PDU session may have multiple QoS flows, such as the QoS flows 105 and 106 that belong to PDU session 104. The UPF node 132 may use a set of service data flow (SDF) templates to map each downlink packet onto a specific QoS flow. The UPF node 132 may receive the set of SDF templates from a session management function (SMF) during setup of the PDU session 104. The SMF may generate the set of SDF templates using information provided from a policy control function (PCF). The UPF node 132 may track various statistics regarding the volume of data transferred by each PDU session, such as PDU session 104, and provide the information to an SMF.

Embodiments described herein may use containerization to implement such microservices. Containerization is the packaging of software code with just the operating system (OS) libraries and dependencies required to run the code to create a single lightweight executable (a container) that runs consistently on any infrastructure. Software platforms, such as Kubernetes, manage containerized workloads and automate the deployment, scaling, and management of containerized applications. Compared to virtual machines (VMs), containers have relaxed isolation properties to share the OS among the applications. Therefore, containers are considered lightweight. A container has its own file system, share of CPU, memory and process space. As they are decoupled from the underlying infrastructure and are portable across clouds and OS distributions.

A cluster is made up of nodes that run containerized applications. Each cluster also has a master (control plane) that manages the nodes and pods of the cluster. A node represents a single machine in a cluster, typically either a physical machine or virtual machine that is located either on-premises or hosted by a cloud service provider. Each node hosts groups of one or more containers (which run applications), and the master communicates with nodes about when to create or destroy containers and how to re-route traffic based on new container alignments. The Kubernetes master is the access point (or the control plane) from which administrators and other users interact with the cluster to manage the scheduling and deployment of containers.

A pod is the basic unit of scheduling for applications running on a cluster. The applications are running in containers, and each pod includes one or more container(s). While pods are able to house multiple containers, one-container-per-pod may also be used. In some situations, containers that are tightly coupled and need to share resources may sit in the same pod. Pods can quickly and easily communicate with one another as if they were running on the same machine. They do still, however, maintain a degree of isolation. Each pod is assigned a unique IP address within the cluster, allowing the application to use ports without conflict.

When a pod gets created, the pod is scheduled to run on a node. The pod remains on that node until the process is terminated, the pod object is deleted, the pod is evicted for lack of resources, or the node fails. In Kubernetes, pods are the unit of replication. If an application becomes overly popular and a pod can no longer facilitate the load, Kubernetes can deploy replicas of the pod to the cluster.

Software container orchestration platforms, such as Amazon® Elastic Kubernetes Service (Amazon EKS), are services for users to run Kubernetes on the cloud of a cloud computing service provider, such as AWS®, without the user needing to install, operate, and maintain their own Kubernetes control plane or nodes. An Amazon EKS cluster comprises of two primary components: the Amazon® EKS control plane and Amazon EKS nodes that are registered with the control plane. The Amazon® EKS control plane comprises of control plane nodes that run the Kubernetes software and the Kubernetes application programming interface (API) server. The control plane may run in an account managed by AWS® or the telecommunication service provider, and the Kubernetes API is exposed via the Amazon® EKS endpoint associated with the cluster. Each Amazon® EKS cluster control plane is single-tenant and unique, and runs on its own set of Amazon® Elastic Compute Cloud (EC2) instances, which provide scalable computing capacity in the AWS® cloud.

However, other types of cloud compute instances or virtual machine instances may be used on various other cloud computing provider service platforms. The cluster control plane may be provisioned across multiple Availability Zones (AZs) and fronted by an Elastic Load Balancing Network Load Balancer. Amazon® EKS may also provision elastic network interfaces in VPC subnets to provide connectivity from the control plane instances to the nodes. Amazon® EKS nodes may run in an AWS® account of the telecommunication service provider and connects to the telecommunication service provider's cluster control plane via the API server endpoint and a certificate file that is created for the cluster.

As disclosed herein, network functions (NFs) of the 5G NR cellular telecommunication network implemented in respective node groups are useful mechanisms for creating pools of resources in the 5G network that can enforce scheduling requirements. These NFs also provide a utility for shifting workloads around in the 5G network during cluster management and updates. Such NFs of the 5G NR cellular telecommunication network may be hosted on a cloud service provider cloud and referred to herein as cloud-native network functions (CNFs).

FIG. 1B is a block diagram depicting a portion of the 5G network of FIG. 1A along with private or public cloud supporting infrastructure according to some embodiments. For example, the system depicted in FIG. 1A can further include a NF manager computing system 140 to manage network function modules for which records are stored at the DNS resolver 101. In some embodiments, the DNS resolver 101 is located in a public cloud server network or a private cloud server network.

In some embodiments, the IMS 134 and the EPC 138 include a number of network function modules 124, where illustrated is a non-exhaustive list for each of the IMS 134 and the EPC 138. For example, the network function modules 124 of the IMS 134 can include proxy call session control function (P-CSCF), interrogating CSCF (I-CSCF), serving CSCF (S-CSCF), telephony application server (TAS), interconnection border control function (IBCF), IP signaling manipulation function (IPSM), and media resource function (MRF). The P-CSCF can be the first point of contact for the IMS user, handling signaling and session control. The I-CSCF can act as the entry point to an operator's IMS network, directing SIP (Session Initiation Protocol) sessions to the appropriate S-CSCF. The S-CSCF can be the central node of the signaling plane, handling the session states, interacting with the Home Subscriber Server (HSS), and performing routing and policy enforcement.

In embodiments, the TAS plays a central role in managing and delivering voice services and other multimedia communications over IP networks, including modern 5G networks. The TAS can be primarily responsible for implementing the voice call processing and control logic for session-based multimedia services. This includes basic call handling functions like call setup, management, and release. The TAS can execute service logic for various applications such as call forwarding, call waiting, and voicemail. The TAS can also support more complex services like unified messaging and conferencing. The TAS can interact with other IMS core elements, such as the S-CSCF and HSS, to manage sessions and subscriber data effectively.

In embodiments, the IBCF serves as a secure entry and exit point for IMS-based communication between different network operators. The IBCF can be responsible for SIP signaling interworking between IMS networks and potential non-IMS networks, ensuring that signaling is handled correctly across network borders. The IBCF can act as a border gateway that controls SIP traffic, managing both the admission and the routing of signaling flows that cross network boundaries. This can include handling Network Address Translation (NAT) traversal and providing topology hiding to enhance security between interconnected networks.

In embodiments, the IPSM, sometimes referred to in specific contexts rather than as a standardized element, can involve the manipulation or adaptation of IP signaling protocols to ensure compatibility and interworking between different systems or network segments. The IPSM can be involved in modifying, translating, or adjusting IP messages as they pass through the network, which can include changing headers, payloads, or both. While not always explicitly defined in all IMS documents, when referenced, IPSM typically helps in scenarios where network elements use varying protocol standards or versions, ensuring seamless integration and communication within and across IMS networks.

In embodiments, the MRF is divided into two main components: Media Resource Function Controller (MRCF) and Media Resource Function Processor (MRFP). The MRCF can controls the media resources within the network and act as a decision-making body that interprets signaling and commands related to media handling. The MRFP can handles the actual media processing tasks such as mixing, transcoding, announcing, and tone generation based on the instructions from the MRFC. In this way, the MRF provides media-related functions that are required for multimedia services, such as playing announcements (e.g., ringback tones or prerecorded messages), performing media transcoding (converting media streams between different codecs), and managing multimedia conferences. The MRF can help in enabling a variety of multimedia services that IMS supports, offering the necessary media processing capabilities to ensure high-quality and interactive multimedia sessions.

In some embodiments, the network function modules 124 of the EPC 138 can include a serving gateway (SGW), a packet data network gateway (PGW), and a mobility management entity (MME), among others. In embodiments, SGW can act as a router, forwarding data packets between the base station (eNodeB) and the PGW. The SGW can be the point of interconnect between the radio side and the core network. The SGW can serve as the local mobility anchor for the data bearers when a device moves across base stations within the LTE and early stage 5G networks. The SGW can manage and stores user data sessions as needed when a user moves from one eNodeB to another within or across LTE and early state 5G networks.

In embodiments, the PGW connects the mobile network to the external networks, which include the internet, private corporate networks, or other telecommunication networks. Thus, the PGW can perform IP address/IP prefix allocation for the user devices, and be the anchor point for mobility between LTE and other 3GPP (3rd Generation Partnership Project) networks (like 2G/3G) or non-3GPP networks such as WiFi. Besides routing, the PGW can also perform deep packet inspection, policy enforcement regarding QoS (Quality of Service), and charging. The PGW can ensure that data traffic is treated according to the policies defined by the network operator.

In embodiments, the MME can be a control node for the LTE access-network. For example, the MME can be responsible for initiating paging and authentication of users, as well as the setting up of bearers. The MME can handle security key management and is involved in the bearer activation/deactivation process. The MME can process signaling between the UE 108 and the core network 130. The MME can manage the states of UE in the areas of idle mode and active mode. Additionally, the MME can be responsible for choosing the SGW and PGW for a UE at the initial attach and at the time of intra-LTE handover involving Core Network (CN) node relocation.

In some embodiments, the NF manager computing system 140 is coupled to or integrated with the DNS resolver 101 and configured to repeatedly perform an attempt to connect, using the DNS resolver 101, to the network function modules 124 located within the core network 130. The NF manager computing system 140, for example, can take the IP details from A/AAA records of the DNS resolver 101, e.g., by executing an application programming interface (API) 142 configured to manage records stored by the DNS resolver. Based on the hosted zoned of the record stored at the DNS resolver, the NF manager computing system 140 can select the correct protocol and start performing health checks of the network function modules 124. For example, the NF manager computing system 140 can employ SIP protocol options to determine connectively to and health of the network function modules 124 at the IMS 134. Further, the NF manager computing system 140 can employ GTP ping attempts at the network function modules 124 at the EPC 138, e.g., to verify connectivity and health of the network function modules 124.

In various embodiments, in response to a number of configured failure counts, a particular network function module 124 can be removed from a particular host zone at the DNS resolver 101. The removal can be performed by removing one or more records at the DNS resolver 101 for the particular network function component, e.g., where the one or more records includes at least a first record that points a domain to an internet protocol address for the network function module. In this way, by removing such records for the network function component, the NF manager computing system 140 steers traffic away from a degraded network function component. Depending on network size and network function capacity, the NF manager computing system 140 can limit the number of network function modules that are removable from the network core 130, e.g., so that a minimum number of network function modules remain configurable and activated. In embodiments, the network size and network function capacity is dependent on network design. For example, if the 5G network 100 is designed with 50% utilization and two P/I/S-CSCF and SGW/PGW modules are used (defined at DNS) with equal capacity (or weight), one of these modules can be taken out based on a configured capacity limit.

In some embodiments, after the degraded network function component is removed from the DNS resolver 101, the NF manager computing system 140 can resume monitoring a health or connectively status of the degraded network function component. After a threshold number of successful connections to the degraded network function component, the NF manager computing system 140 can add the one or more records for the particular network function back into the DNS resolver 101.

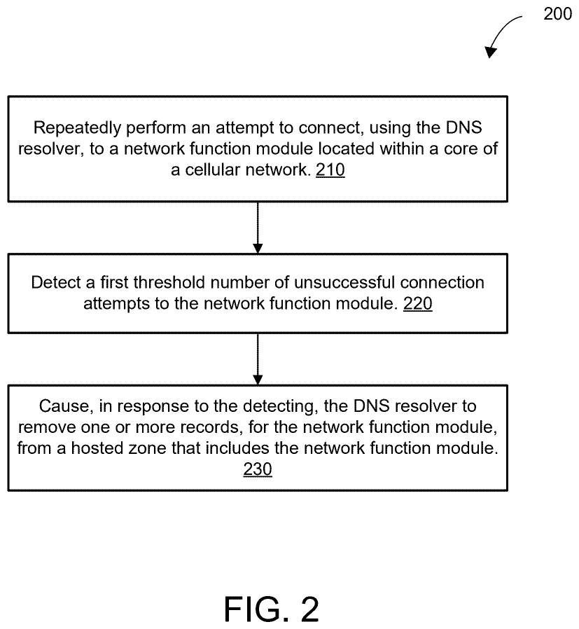

FIG. 2 is a flow diagram of a method 200 for managing a degraded network function (NF) component deployed over a private or public cloud according to some embodiments. The method 200 may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 200 is performed by the NF manager computing system 140 of FIG. 1B. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 210, the processing logic repeatedly performs an attempt to connect, using the DNS resolver 101, to a network function module located within a core of a cellular network. In some embodiments, the network function module is located within an internet protocol (IP) multimedia subsystem of the core of the cellular network. In such embodiments, performing the attempt to connect includes performing a session initiation protocol (SIP) option for accessing the network function module using the DNS resolver. In other embodiments, the network function module is located within an evolved packet core (EPC) of the core of the cellular network. In such embodiments, performing the attempt to connect includes performing a general packet radio service (GPRS) tunneling protocol (GTP) ping attempt of the network function module.

At operation 220, the processing logic detects a first threshold number of unsuccessful connection attempts to the network function module, e.g., 6, 12, 15, 18, or the like. For example, when P-CSCF wants to select I-CCSF and checks with DNS resolver 101. Because DNS is continuously checking the availability of I-CSCF if one of the I-CSCF is not responding or giving fives times responses for SIP options and the same when SMF in 5GC and PGW in 4G select P-CSCF to PCO options. As one example, after 12 consecutive failures assuming round trip timer as 500 milliseconds and time-to-live timer at DNS as 15 minutes. In embodiments, the same is applicable when MME selects SGW (serving gateway) and PGW (packet gateway) resolver will do GTP ping to SGW and PGW in response to 12 consecutive failures assuming round trip timer as 500 milliseconds and time-to-live timer at DNS as 15 minutes. However, it is configurable how much capacity can be taken out at a time to avoid major issues based on priority and weight of the network functions.

At operation 230, the processing logic causes, in response to the detecting, the DNS resolver to remove one or more records, for the network function module, from a hosted zone that includes the network function module. In embodiments, causing the DNS resolver to remove the one or more records includes executing an application programming interface (API) configured to manage records stored by the DNS resolver 101. For example, the API can enable the processing logic to dynamically access, change, remove, or add record entries at the DNS resolver 101.

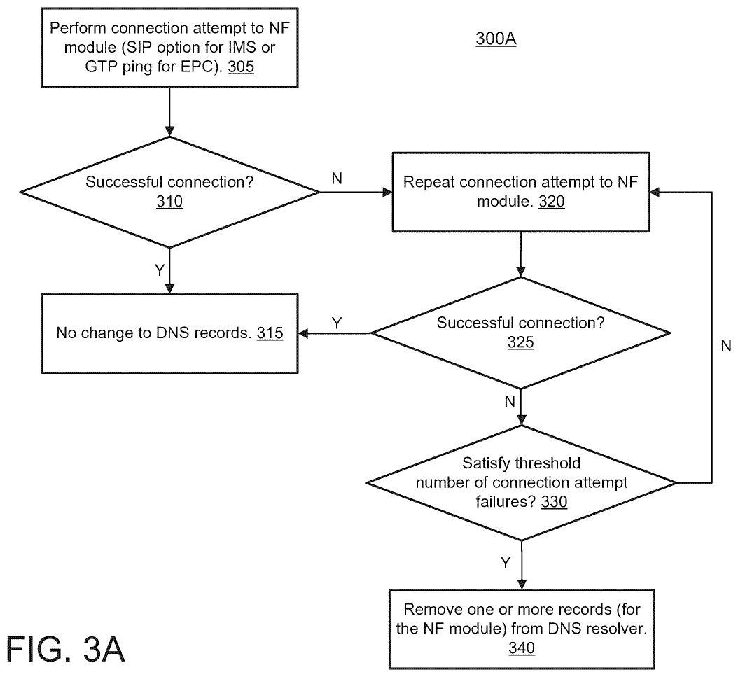

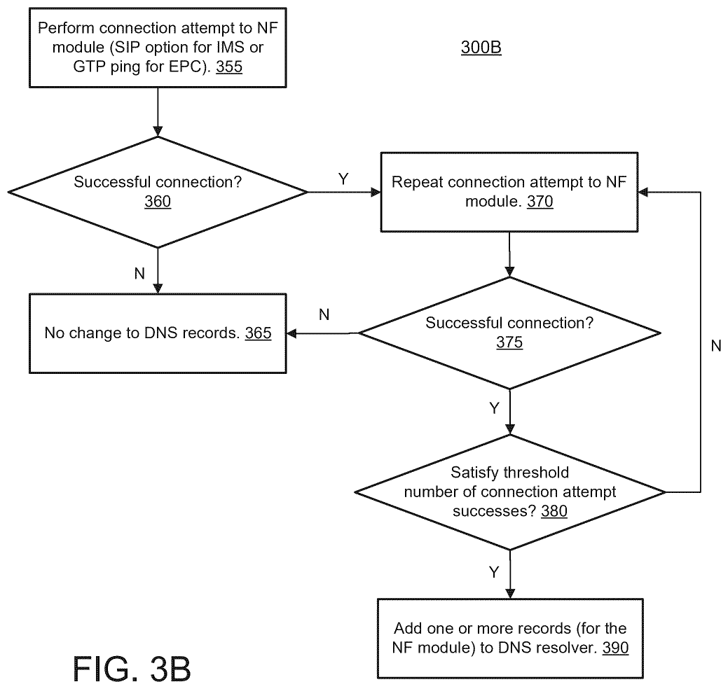

FIG. 3A is a flow diagram of a method 300A for removing one or more records of the degraded NF component from a DNS resolver according to some embodiments. The method 300A may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300A is performed by the NF manager computing system 140 of FIG. 1B. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

At operation 305, the processing logic performs a connection attempt to a network function module, e.g., via a SIP option for the IMS 134 or a GTP ping for the EPC 138.

At operation 310, the processing logic determines whether the connection attempt was successful, e.g., by detecting whether an acknowledgement was received.

At operation 315, in response to, at operation 310, the connection attempt being successful, the processing logic makes no change to DNS records or information at the DNS resolver 101 for the network function module.

At operation 320, in response to, at operation 310, the connection attempt not being successful, the processing logic repeats the connection attempt to the network function module.

At operation 325, the processing logic again determines whether the repeated connection attempt was successful. If it was successful, the method 300A can again flow to operation 315, where no change it made to the DNS records or information at the DNS resolver 101 for the network function module.

At operation 330, in response to, at operation 325, the connection attempt was unsuccessful, the processing logic determines whether the number of connection attempt failures satisfies a threshold number of attempt failures. If not satisfying the threshold number, the processing logic can loop back to operation 320, where further connection attempts are initiated at the network function module. To “satisfy” the threshold number can be understood to mean to at least equal or be greater than the threshold number.

At operation 340, in response to, at operation 330, the number of connection attempts satisfies the threshold number, the processing logic removes one or more records for the network function module from the DNS resolver 101. To remove the one or more records can include executing an application programming interface (API) configured to manage records stored by the DNS resolver 101. In some embodiments, the processing logic further limits a number of network function modules that are removable from the core of the cellular network based on a network size and a network function capacity of the core of the cellular network.

FIG. 3B is a flow diagram of a method 300B for adding one or more records of a revived NF component to a DNS resolver according to some embodiments. The method 300B may be performed by processing logic that may comprise hardware (e.g., circuitry, dedicated logic, programmable logic, microcode, etc.), software (e.g., instructions run on a processing device to perform hardware simulation), or a combination thereof. In one embodiment, the method 300B is performed by the NF manager computing system 140 of FIG. 1B. Although shown in a particular sequence or order, unless otherwise specified, the order of the operations can be modified. Thus, the illustrated embodiments should be understood only as examples, and the illustrated operations can be performed in a different order, while some operations can be performed in parallel. Additionally, one or more operations can be omitted in some embodiments. Thus, not all illustrated operations are required in every embodiment, and other process flows are possible.

The method 300B can flow from the method 300 of FIG. 3A, e.g., be performed after removal of the one or more records from the DNS resolver 101 for the network function module. At operation 355, the processing logic performs a connection attempt to the network function module, e.g., via a SIP option for the IMS 134 or a GTP ping for the EPC 138.

At operation 360, the processing logic determines whether the connection attempt was successful, e.g., by detecting whether an acknowledgement was received.

At operation 365, in response to, at operation 360, not successfully connecting to the network function module, the processing logic makes no change to DNS records or information at the DNS resolver 101 for the network function module.

At operation 370, in response to, at operation 360, successfully connecting to the network function module, the processing logic repeats the connection attempt to the network function module.

At operation 375, the processing logic again determines whether the repeated connection attempt was successful. If not successful, the method 300A can again flow to operation 365, where no change it made to the DNS records or information at the DNS resolver 101 for the network function module. In this way, the processing logic repeatedly performs the attempt to connect to the network function module, using the DNS resolver, located within the core of the cellular network.

At operation 380, in response to, at operation 375, the repeated connection attempt being successful, the processing logic determines whether the number of connection attempt successes satisfies a threshold number of successful attempts. If not satisfying the threshold number of successful attempts, the processing logic loops back to operation 370, where further connection attempts are initiated at the network function module. To “satisfy” the threshold number can be understood to mean to at least equal or be greater than the threshold number.

At operation 390, in response to, at operation 380, detecting the threshold number of successful connection attempts to the network function module (e.g., 8, 12, 24, 30, or the like), the processing logic causes the DNS resolver 101 to add one or more records, for the network function module, to a hosted zone that includes the network function module.

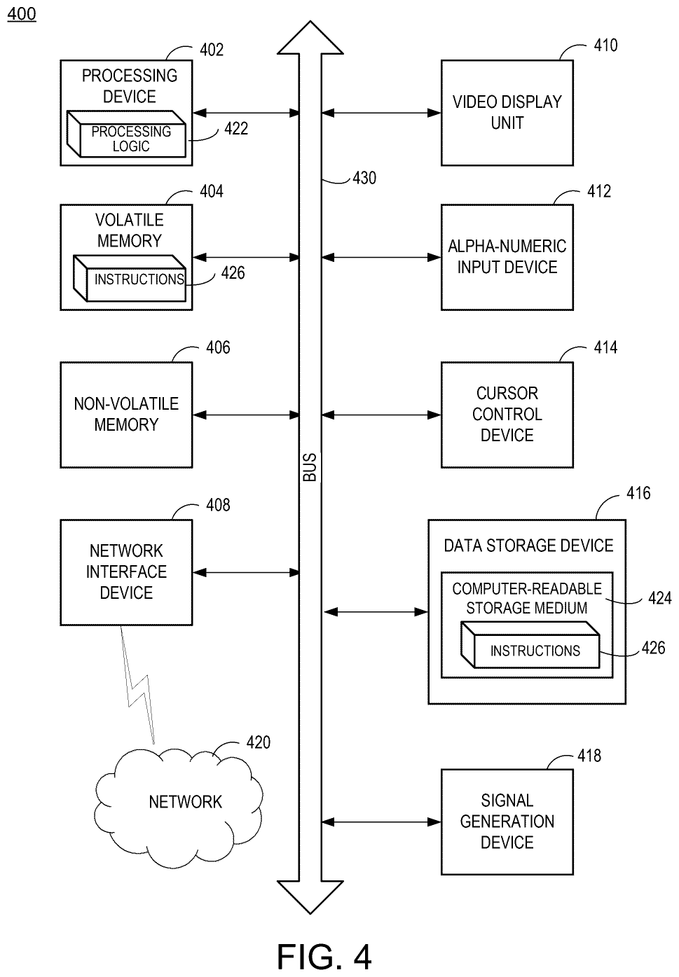

FIG. 4 illustrates a block diagram illustrating an exemplary computer device 400 (or computing device), in accordance with implementations of the present disclosure. Computer device 400 can correspond to the NF manger computing system 140 (or device), as described above. Example computer device 400 can be connected to other computer devices in a LAN, an intranet, an extranet, and/or the Internet. Computer device 400 can operate in the capacity of a server in a client-server network environment. Computer device 400 can be a personal computer (PC), a set-top box (STB), a server, a network router, switch or bridge, or any device capable of executing a set of instructions (sequential or otherwise) that specify actions to be taken by that device. Further, while only a single example computer device is illustrated, the term “computer” shall also be taken to include any collection of computers that individually or jointly execute a set (or multiple sets) of instructions to perform any one or more of the methods discussed herein.

Example computer device 400 can include a processing device 402 (also referred to as a processor, CPU, or GPU), a volatile memory 404 (or main memory, e.g., read-only memory (ROM), flash memory, dynamic random access memory (DRAM) such as synchronous DRAM (SDRAM), etc.), a non-volatile memory 406 (e.g., flash memory, static random access memory (SRAM), etc.), and a secondary memory (e.g., a data storage device 416), which can communicate with each other via a bus 430.

Processing device 402 (which can include processing logic 422) represents one or more general-purpose processing devices such as a microprocessor, central processing unit, or the like. More particularly, processing device 402 can be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 402 can also be one or more special-purpose processing devices such as an ASIC, a FPGA, a digital signal processor (DSP), network processor, or the like. In accordance with one or more aspects of the present disclosure, processing device 402 can be configured to execute instructions performing the method disclosed herein.

Example computer device 400 can further comprise a network interface device 408, which can be communicatively coupled to a network 420. Example computer device 400 can further comprise a video display 410 (e.g., a liquid crystal display (LCD), a touch screen, or a cathode ray tube (CRT)), an alphanumeric input device 412 (e.g., a keyboard), a cursor control device 414 (e.g., a mouse), and an acoustic signal generation device 418 (e.g., a speaker).

Data storage device 416 can include a computer-readable storage medium (or, more specifically, a non-transitory computer-readable storage medium) 424 on which is stored one or more sets of executable instructions 426. In accordance with one or more aspects of the present disclosure, executable instructions 426 can comprise executable instructions performing the method disclosed herein.

Executable instructions 426 can also reside, completely or at least partially, within volatile memory 404 and/or within processing device 402 during execution thereof by example computer device 400, volatile memory 404 and processing device 402 also constituting computer-readable storage media. Executable instructions 426 can further be transmitted or received over a network via network interface device 408.

While the computer-readable storage medium 424 is shown in FIG. 4 as a single medium, the term “computer-readable storage medium” or “non-transitory computer-readable storage medium storing instructions” or “computer-readable instructions” should be taken to include a single medium or multiple media (e.g., a centralized or distributed database, and/or associated caches and servers) that store the one or more sets of operating instructions. The term “computer-readable storage medium” shall also be taken to include any medium that is capable of storing or encoding a set of instructions for execution by the machine that cause the machine to perform any one or more of the methods described herein. The term “computer-readable storage medium” shall accordingly be taken to include, but not be limited to, solid-state memories, and optical and magnetic media.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “identifying,” “determining,” “storing,” “adjusting,” “causing,” “returning,” “comparing,” “creating,” “stopping,” “loading,” “copying,” “throwing,” “replacing,” “performing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Examples of the present disclosure also relate to an apparatus for performing the methods described herein. This apparatus can be specially constructed for the required purposes, or it can be a general-purpose computer system selectively programmed by a computer program stored in the computer system. Such a computer program can be stored in a computer readable storage medium, such as, but not limited to, any type of disk including optical disks, CD-ROMs, and magnetic-optical disks, read-only memories (ROMs), random access memories (RAMs), EPROMs, EEPROMs, magnetic disk storage media, optical storage media, flash memory devices, other type of machine-accessible storage media, or any type of media suitable for storing electronic instructions, each coupled to a computer system bus.

The methods and displays presented herein are not inherently related to any particular computer or other apparatus. Various general-purpose systems can be used with programs in accordance with the teachings herein, or it may prove convenient to construct a more specialized apparatus to perform the required method steps. The required structure for a variety of these systems will appear as set forth in the description below. In addition, the scope of the present disclosure is not limited to any particular programming language. It will be appreciated that a variety of programming languages can be used to implement the teachings of the present disclosure.

It is to be understood that the above description is intended to be illustrative, and not restrictive. Many other implementation examples will be apparent to those of skill in the art upon reading and understanding the above description. Although the present disclosure describes specific examples, it will be recognized that the systems and methods of the present disclosure are not limited to the examples described herein, but can be practiced with modifications within the scope of the appended claims. Accordingly, the specification and drawings are to be regarded in an illustrative sense rather than a restrictive sense. The scope of the present disclosure should, therefore, be determined with reference to the appended claims, along with the full scope of equivalents to which such claims are entitled.

Other variations are within the scope of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within the range, unless otherwise indicated herein, and each separate value is incorporated into the specification as if it were individually recited herein. In at least one embodiment, the use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B and C,” unless specifically stated otherwise or otherwise clearly contradicted by context, is otherwise understood with the context as used in general to present that an item, term, etc., may be either A or B or C, or any nonempty subset of the set of A and B and C. For instance, in an illustrative example of a set having three members, conjunctive phrases “at least one of A, B, and C” and “at least one of A, B and C” refer to any of the following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, the number of items in a plurality is at least two, but can be more when so indicated either explicitly or by context. Further, unless stated otherwise or otherwise clear from context, the phrase “based on” means “based at least in part on” and not “based solely on. ”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. In at least one embodiment, a set of non-transitory computer-readable storage media comprises multiple non-transitory computer-readable storage media and one or more of individual non-transitory storage media of multiple non-transitory computer-readable storage media lack all of the code while multiple non-transitory computer-readable storage media collectively store all of the code. In at least one embodiment, executable instructions are executed such that different instructions are executed by different processors.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

In description and claims, the terms “coupled” and “connected,” along with their derivatives, may be used. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to actions and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transform that electronic data into other electronic data that may be stored in registers and/or memory. As non-limiting examples, a “processor” may be a network device or a MACsec device. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, the terms “system” and “method” are used herein interchangeably insofar as the system may embody one or more methods, and methods may be considered a system.

In the present document, references may be made to obtaining, acquiring, receiving, or inputting analog or digital data into a sub-system, computer system, or computer-implemented machine. In at least one embodiment, the process of obtaining, acquiring, receiving, or inputting analog and digital data can be accomplished in a variety of ways, such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface, or an inter-process communication mechanism.

Although descriptions herein set forth example embodiments of described techniques, other architectures may be used to implement described functionality, and are intended to be within the scope of this disclosure. Furthermore, although specific distributions of responsibilities may be defined above for purposes of description, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described.

Rather, specific features and acts are disclosed as exemplary forms of implementing the claims.

What is claimed is:

1. A computing system for functional integration with a domain name system (DNS) resolver, wherein the computing system comprises:
one or more processing devices; and
memory communicatively coupled with and readable by the one or more processing devices and having stored therein processor-readable instructions which, when executed by the one or more processing devices, cause the one or more processing devices to perform operations comprising:
repeatedly performing an attempt to connect, using the DNS resolver, to a network function module located within a core of a cellular network; and
in response to detecting a first threshold number of unsuccessful connection attempts to the network function module, causing the DNS resolver to remove one or more records, for the network function module, from a hosted zone that includes the network function module.

2. The computing system of claim 1, wherein the DNS resolver is located in a public cloud server network and the cellular network comprises a 5G wireless network.

3. The computing system of claim 1, wherein causing the DNS resolver to remove the one or more records comprises executing an application programming interface (API) configured to manage records stored by the DNS resolver.

4. The computing system of claim 1, wherein the one or more records comprises at least a first record that points a domain to an internet protocol address for the network function module.

5. The computing system of claim 1, wherein the network function module is located within an internet protocol (IP) multimedia subsystem of the core of the cellular network and performing the attempt to connect comprises performing a session initiation protocol (SIP) option for accessing the network function module using the DNS resolver.

6. The computing system of claim 1, wherein the network function module is located within an evolved packet core (EPC) of the core of the cellular network and performing the attempt to connect comprises performing a general packet radio service (GPRS) tunneling protocol (GTP) ping attempt of the network function module.

7. The computing system of claim 1, wherein, after removal of the one or more records from the DNS resolver, the operations further comprise:
repeatedly performing the attempt to connect to the network function module, using the DNS resolver, located within the core of the cellular network; and
in response to detecting a second threshold number of successful connection attempts to the network function module, causing the DNS resolver to add one or more records, for the network function module, to a hosted zone that includes the network function module.

8. The computing system of claim 1, wherein the operations further comprise limiting a number of network function modules that are removable from the core of the cellular network based on a network size and a network function capacity of the core of the cellular network.

9. A method for operating a computing system for functional integration with a domain name system (DNS) resolver, wherein the method comprising:
repeatedly performing an attempt to connect, using the DNS resolver, to a network function module located within a core of a cellular network;
detecting a first threshold number of unsuccessful connection attempts to the network function module; and
causing, in response to the detecting, the DNS resolver to remove one or more records, for the network function module, from a hosted zone that includes the network function module.

10. The method of claim 9, wherein causing the DNS resolver to remove the one or more records comprises executing an application programming interface (API) configured to manage records stored by the DNS resolver.

11. The method of claim 9, wherein the one or more records comprises at least a first record that points a domain to an internet protocol address for the network function module.

12. The method of claim 9, wherein the network function module is located within an internet protocol (IP) multimedia subsystem of the core of the cellular network and performing the attempt to connect comprises performing a session initiation protocol (SIP) option for accessing the network function module using the DNS resolver.

13. The method of claim 9, wherein the network function module is located within an evolved packet core (EPC) of the core of the cellular network and performing the attempt to connect comprises performing a general packet radio service (GPRS) tunneling protocol (GTP) ping attempt of the network function module.

14. The method of claim 9, wherein, after removal of the one or more records from the DNS resolver, the operations further comprise:
repeatedly performing the attempt to connect to the network function module, using the DNS resolver, located within the core of the cellular network; and
in response to detecting a second threshold number of successful connection attempts to the network function module, causing the DNS resolver to add one or more records, for the network function module, to a hosted zone that includes the network function module.

15. The method of claim 9, further comprising limiting a number of network function modules that are removable from the core of the cellular network based on a network size and a network function capacity of the core of the cellular network.

16. One or more non-transitory, computer-readable storage media having computer-readable instructions thereon which, when executed by one or more processing devices, cause the one or more processing devices to perform operations comprising:
repeatedly performing an attempt to connect, using a domain name system (DNS) resolver, to a network function module located within a core of a cellular network;
detecting a first threshold number of unsuccessful connection attempts to the network function module; and
causing, in response to the detecting, the DNS resolver to remove one or more records, for the network function module, from a hosted zone that includes the network function module.

17. The non-transitory, computer-readable storage media of claim 16, wherein causing the DNS resolver to remove the one or more records comprises executing an application programming interface (API) configured to manage records stored by the DNS resolver, wherein the operations further comprise limiting a number of network function modules that are removable from the core of the cellular network based on a network size and a network function capacity of the core of the cellular network.

18. The non-transitory, computer-readable storage media of claim 16, wherein the network function module is located within an internet protocol (IP) multimedia subsystem of the core of the cellular network and performing the attempt to connect comprises performing a session initiation protocol (SIP) option for accessing the network function module using the DNS resolver.

19. The non-transitory, computer-readable storage media of claim 16, wherein the network function module is located within an evolved packet core (EPC) of the core of the cellular network and performing the attempt to connect comprises performing a general packet radio service (GPRS) tunneling protocol (GTP) ping attempt of the network function module.

20. The non-transitory, computer-readable storage media of claim 16, wherein, after removal of the one or more records from the DNS resolver, the operations further comprise:
repeatedly performing the attempt to connect to the network function module, using the DNS resolver, located within the core of the cellular network; and
in response to detecting a second threshold number of successful connection attempts to the network function module, causing the DNS resolver to add one or more records, for the network function module, to a hosted zone that includes the network function module.
